(19) United States
(12) Patent Application Publication
(10) Pub. No.: US 2016/0187145 A1
(43) Pub. Date: Jun. 30, 2016

(54) NAVIGATING INSTRUMENT AND NAVIGATING SYSTEM EMPLOYING SAME

(71) Applicant: HON HAI PRECISION INDUSTRY CO., LTD., New Taipei (TW)

(72) Inventor: ZONG-YUAN SUN, New Taipei (TW)

(21) Appl. No.: 14/689,975

(22) Filed: Apr. 17, 2015

(30) Foreign Application Priority Data
Dec. 31, 2014 (CN) 201410852790.6

(51) Int. Cl. G01C 21/20; G01C 21/26; G01S 19/42; G06K 7/10

(52) U.S. Cl. CPC G01C 21/20; G06K 7/10366; G01C 21/26; G01S 19/42

(57) ABSTRACT

A navigating instrument communicates with a plurality of electronic tags arranged on a road. The navigating instrument includes a sensor module, a control module, a reader module, and an indicating module. The sensor module detects a movement of the navigating instrument. The control module activates or disables the navigating instrument according to a detected result by the sensor module. The reader module reads information from the electronic tags. The indicating module emits indicating signals according to the information. A navigating system employing the navigating instrument is also provided.

### FIELD

The subject matter herein generally relates to a navigating instrument, and particularly relates to a navigating instrument providing audio indication and a navigating system employing the navigating instrument.

### BACKGROUND

People with weak eyesight need more assistant instruments, such as a navigating instrument with audio indication.

### BRIEF DESCRIPTION OF THE DRAWINGS

Implementations of the present technology will now be described, by way of example only, with reference to the attached figures.

FIG. 1 is a block diagram of an exemplary embodiment of a navigating instrument.

FIG. 2 is a block diagram of a navigating system employing the navigating instrument of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

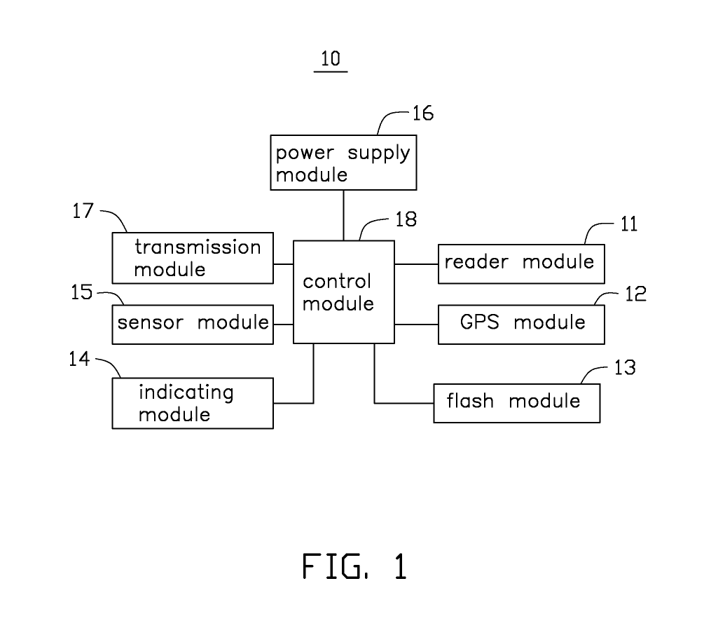

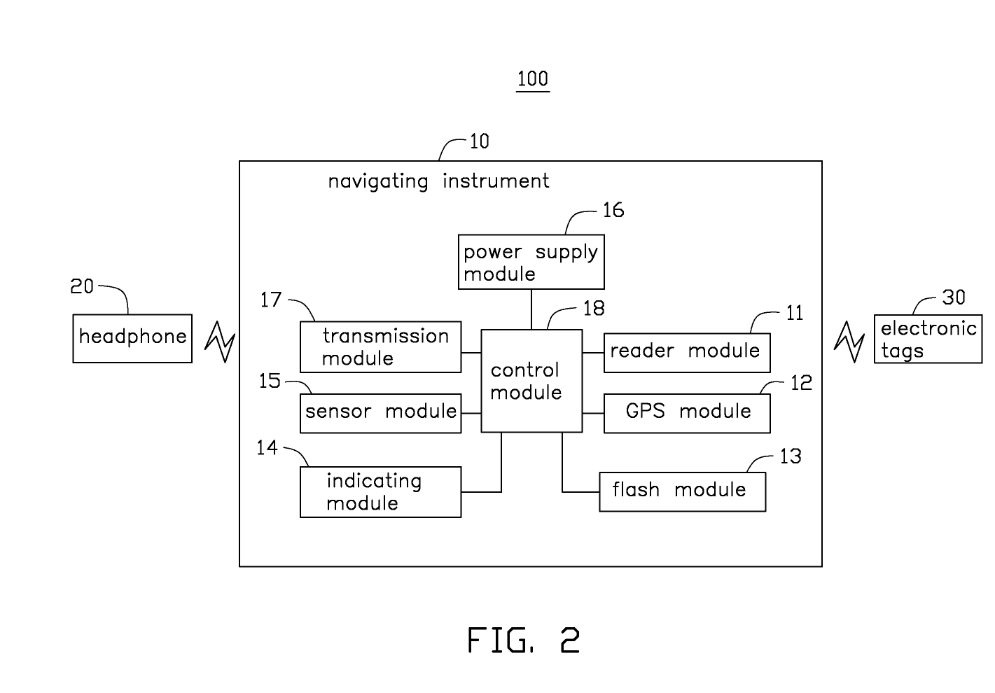

FIGS. 1 and 2 illustrate at least one embodiment of a navigating instrument 10 applied in a navigating system 100. The navigating system 100 includes a headphone 20 and a plurality of electronic tags 30. The navigating instrument 10 is wirelessly connected to the headphone 20 and the electronic tags 30 to read information from the electronic tags 30 and transmit the information to the headphone 20, thereby providing audio indication to a user. The navigating instrument 10 can be applied to people with weak eyesight and can be a guidance stick or a wrist ring that can be portably carried.

The navigating instrument 10 includes a reader module 11, a global positioning system (GPS) module 12, a flash module 13, an indicating module 14, a sensor module 15, a power supply module 16, a transmission module 17, and a control module 18. The control module 18 is electrically connected to the reader module 11, the GPS module 12, the flash module 13, the indicating module 14, the sensor module 15, the power supply module 16, and the transmission module 17 to process data and control all the modules. The reader module 11 is configured to read information from the electronic tags 30 on the sidewalks. The GPS module 12 is configured to capture position information to provide a position to family members of the user. The flash module 13 is configured to flash to notify other passersby that they should pay attention to and give way to the user. The indicating module 14 is configured to emit indicating signals to notify other passersby. In at least one embodiment, the indicating module 14 can provide audio and/or vibrancy to notify the user about road condition. The sensor module 15 is configured to detect a state of the navigating instrument 10 to control the navigating instrument 10. In at least one embodiment, the sensor module 15 can be a accelerometer sensor, which can be coupled to an end of the navigating instrument 10 for example when the navigating instrument 10 is a guidance stick. Thereby the sensor module 15 can touch the ground. When the navigating instrument 10 is in a moving state with the user, an acceleration is generated when the navigating instrument 10 moves to or away the ground, the sensor module 15 detects the acceleration and transmits to a first trigger signal to the control module 18 to activate the navigating instrument 10. Otherwise, when the navigating instrument 10 is in an actionless state, the sensor module 15 does not detect any acceleration, and the sensor module 15 transmits a second trigger signal to the control module 18 to disable the navigating instrument 10, thereby saving power. The power supply module 16 is configured to supply power for the navigating instrument 10. The transmission module 17 is configured to establish communication with the headphone 20 to transmit data to the headphone 20. In at least one embodiment, the transmission module 17 can be a Bluetooth® module, the headphone 20 can be a Bluetooth® headphone.

The headphone 20 is configured to receive data from the transmission module 17. In at least one embodiment, the headphone 20 receives data that including audio information, such as road condition and attention affairs, to help the user.

In other embodiments, the navigating instrument 10 can be used to notify the user by the audio and/or vibrancy emitted by the indicating module 14, and thereby omitting the transmission module 17 and the headphone 20.

The electronic tags 30 can be arranged on sidewalks of the road by distance between each other, and be arranged on corners and some special road condition positions. The electronic tags 30 are configured to store information about road name, road conditions, surrounding conditions, that helps the user know about the environment. In at least one embodiment, the electronic tags 30 can be ultrahigh frequency electronic tags having a signals transmission range. When the navigating instrument 10 enters the signals transmission range of the electronic tags 30, the navigating instrument 10 can receive signals from the electronic tags 30.

When a user carries the navigating instrument 10 and the headphone 20 and walks on a sidewalk arranging the plurality of electronic tags, the sensor module 15 detects the navigating instrument 10 is moving, thereby transmits a first trigger signal to the control module 18 to activate the navigating instrument 10. The reader module 11 receives information from the electronic tags 30 in range and further forwards the information to the control module 18. The control module 18 processes the information and transmits to the indicating module 14. The indicating module 14 vibrates and emits audio guidance to notify the user and other passersby. Meanwhile, the control module 18 transmits processed information to the headphone 20 to provide audio guidance to the user. When at night, the flash module 13 emits flash to notify passersby to give way to the user. Family members can locate the user via the GPS module 12 to help the user when in need.

The navigating system 100 reads the information from the electronic tags 30 on the road via the navigating instrument 10, the navigating instrument 10 further transmits the information to the headphone 20 to notify the user that the road conditions and surrounding conditions by audio guidance, which is convenient for the people with weak eyesight.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A navigating instrument communicating with a plurality of electronic tags, the navigating instrument comprising:
a sensor module configured to detect a movement of the navigating instrument;
a control module configured to activate or disable the navigating instrument according to a detected result by the sensor module;
a reader module configured to read information from the electronic tags; and
an indicating module configured to emit indicating signals according to the information of the electronic tags read by the reader module.

2. The navigating instrument as claimed in claim 1, wherein the sensor module is coupled to an end of the navigating instrument, when the navigating instrument moves, an acceleration is generated, the sensor module transmits a first trigger signal to the control module according to the acceleration, thereby the control module activates the navigating instrument; when the navigating instrument stop moving, the sensor module detects no acceleration and transmits a second trigger signal to the control module, thereby the control module disables the navigating instrument.

3. The navigating instrument as claimed in claim 1, further comprising a global positioning system (GPS) module configured to locate the navigating instrument.

4. The navigating instrument as claimed in claim 1, wherein the indicating module is configured to provide audio and vibrancy.

5. The navigating instrument as claimed in claim 1, wherein the navigating instrument is one of a guidance stick and a wrist ring.

6. The navigating instrument as claimed in claim 1, further comprising a power supply module configured to supply power for the navigating instrument.

7. The navigating instrument as claimed in claim 1, further comprising a transmission module electrically connected to the control module and configured to establish communication with a headphone.

8. The navigating instrument as claimed in claim 7, wherein the reader module transmits the information read from the electronic tags to the control module, the control module processes the information and transmits the processed information to the indicating module and the transmission module, the transmission module transmits the processed information to the headphone, thus both the indicating module and the headphone output a notice.

9. The navigating instrument as claimed in claim 8, wherein the transmission module is a Bluetooth® module, the headphone is a Bluetooth® headphone.

10. A navigating system comprising:
a plurality of electronic tags configured to store information of road condition; and
a navigating instrument communicating with the electronic tags, the navigating instrument comprising:
a reader module configured to read information from the electronic tags;
a control module configured to process the information and provide audio guidance.

11. The navigating system as claimed in claim 10, wherein the navigating instrument further comprises a sensor module configured to detect a movement of the navigating instrument, when the navigating instrument moves, an acceleration is generated, the sensor module transmits a first trigger signal to the control module according to the acceleration, thereby the control module activates the navigating instrument; when the navigating instrument stop moving, the sensor module detects no acceleration and transmits a second trigger signal to the control module, thereby the control module disables the navigating instrument.

12. The navigating system as claimed in claim 10, wherein the navigating instrument further comprises a global positioning system (GPS) module configured to locate the navigating instrument.

13. The navigating system as claimed in claim 10, wherein the navigating instrument is a guidance stick or a wrist ring.

14. The navigating system as claimed in claim 10, wherein the navigating instrument further comprises a power supply module configured to supply power for the navigating instrument.

15. The navigating system as claimed in claim 10, further comprising a headphone, wherein the navigating instrument further comprises a transmission module electrically connected to the control module and configured to establish communication with the headphone and transmit the information processed by the control module to the headphone for providing the audio guidance.

16. The navigating system as claimed in claim 10, wherein the navigating instrument further comprises an indicating module configured to emit indicating signals according to the information of the electronic tags read by the reader module, the indicating signals include audio and vibrancy.

17. The navigating system as claimed in claim 16, wherein the reader module transmits the information read from the electronic tags to the control module, the control module processes the information and transmits the processed information to the indicating module and the transmission module, the transmission module transmits the processed information to the headphone, thus both the indicating module and the headphone notice a user of the navigating instrument and passersby.

18. The navigating system as claimed in claim 17, wherein the transmission module is a Bluetooth® module, the headphone is a Bluetooth® headphone.

19. The navigating system as claimed in claim 10, wherein the electronic tags are ultrahigh frequency electronic tags having a signals transmission range.

20. The navigating system as claimed in claim 10, wherein the electronic tags are arranged on sidewalks of the road by distance between each other, and are arranged on corners and some special road condition positions.
